(19) United States
(12) Patent Application Publication
(10) Pub. No.: US 2007/0039027 A1
(43) Pub. Date: Feb. 15, 2007

(54) RF based display control system

(75) Inventors: Billy Zeyher, Sugar Hill, GA (US); Jeffrey A. McNall, Hayward, CA (US)

Correspondence Address: Jonathan O. Owens;HAVERSTOCK & OWENS LLP, 162 North Wolfe Road, Sunnyvale, CA, 94086, US

(73) Assignees: Sony Corporation; Sony Electronics Inc.

(21) Appl. No.: 11/187,785

(22) Filed: Jul. 22, 2005

(51) Int. Cl. H04N 7/18

(52) U.S. Cl. 725/74

(57) ABSTRACT

A radio frequency (RF) based control system includes a master transmitter and a control device that utilize an RF distribution system, such as a master antenna television (MATV) system, to send remote control commands to remotely connected network devices. Each control command is addressed by group to reach several network devices at the same time or is addressed by a single device. The control system is configured to provide signaling in one direction, from the control device to the network devices. Status feed back is not provided by a network device to the control device. Each network device is a display device, such as a television. Alternatively, each network device is any device capable of being controlled be an external means.

### FIELD OF THE INVENTION

The present invention relates to the field of display control systems. More particularly, the present invention relates to the field of display control systems within a distributed environment.

### BACKGROUND OF THE INVENTION

MATV (Master Antenna Television) provides means by which many apartment houses, hotels, schools and other multi-unit buildings distribute TV and FM signals to a number of receivers. In order to accomplish this without a loss of signal quality, these systems must be carefully planned and engineered through the effective use of MATV equipment and techniques.

An MATV system is basically a network of cables and specially designed components that process and amplify TV and FM signals and distribute them from one central location. In a configuration where there are many receivers in a building, it is expensive to install and maintain separate antennas for each receiver. Such a configuration is also unsightly, and reception may suffer due to the interaction between multiple antennas, causing interference problems.

The MATV system concept is functionally broken down into two components, a head end and a distribution system. The head end includes an antenna installation to receive the desired signals, processing equipment to filter the signals and remove interference, and a distribution amplifier to amplify the signals to the level required to provide an adequate signal to every receiver in the system. Antenna amplifiers, traps, filters, antenna mixing units, and UHF converters are among the equipment used in the head end portion. A high quality antenna and a front end amplification process optimize signal quality at a front end of the head end system, thereby minimizing inherent noise prior to the main amplification stages. This signal feed is then passed through channel equalization stages to balance all incoming channels before additional filtering stages are used to minimize or reject unwanted interference sources. Clients also have the option of inserting additional UHF/ VHF channels for special features like information services (Guest Information), Video programs (pay per view) or Music services, before the signal is then fed to the main launch amplification for onward distribution.

The distribution system enables an adequate signal to be delivered to each receiver. The design objective of the distribution system is to provide a clean signal to the receivers by isolating each receiver from the system and by delivering the proper amount of signal to each receiver. The distribution system typically includes trunk lines, splitters, feeder lines, and tapoffs. Other equipment used includes line taps, variable isolation wall taps, coaxial cable, and band separators. The signal output from the launch amplifier is provided to a structured cabling system constructed of high grade cable and screened outlet plates, which are installed within the premises to provide each receiver with the required service package. Structured cabling systems vary greatly in size, dependent upon the physical layout of the premises they are being installed into and the number of outlet points required to support the end-user customer requirements.

Various commercial premises, including hotels, offices, housing developments and holiday parks, utilize some form of structured cable system to supply an array of different programs and information services to their end-user customers. Such multi-point distribution systems typically incorporate a form of MATV system, which is dependent upon the client's specific needs. In many multi-point configurations, each receiver is individually controlled by an end user using a remote control, or direct input means, to provide control commands directly to the individual receiver. For example, a hotel guest controls the television within their hotel room. However, in some multi-point configurations, it is often desired that each receiver is centrally controlled so that all receivers within a given network are controlled by a central control device.

### SUMMARY OF THE INVENTION

In one aspect, a control system to centrally control a plurality of network devices includes an RF distribution system, a plurality of receiver devices coupled to the RF distribution system, one or more of the plurality of network devices coupled to each receiver device, and a central control point coupled to the RF distribution network. The control system provides one-directional signaling from the central control point through the RF distribution network and the plurality of receivers to the plurality of network devices, wherein the central control point transmits control signals to a select one or more of the plurality of network-devices. The RF distribution system comprises a master antenna television system. At least one of the plurality of network devices comprises an audio/video device. The central control point comprises a control device to generate the control signals and a master transmitter to transmit the control signals to the RF distribution system. The master transmitter and the control device comprise independent components. The master transmitter and the control device are coupled via a serial communication connection to send the control signals from the control device to the master transmitter. Alternatively, the master transmitter and the control device are integrated within a single device. The control device further comprises a user interface for inputting control commands by a user, wherein the control commands are converted to the control signals by the controller according to a control system application. The control device further comprises a scheduling algorithm to automatically generate control commands, wherein the control commands are converted to the control signals by the controller according to a control system application. Each receiver box is identified by a device address, and each control signal includes one or more device addresses that designate the corresponding one or more receiver devices to which the control signal is intended. Each receiver device identified by the control signal transmits control commands to the one or more network devices coupled to the identified receiver device. In one embodiment, at least one of the plurality of receiver devices is Sony Infrared Remote Control System (SIRCS) compatible and the one or more network devices coupled to each SIRCS compatible receiver device is a SIRCS compatible network device. The system includes one receiver device for each network device. Alternatively, each receiver device supports multiple network devices.

In another aspect, a method of centrally controlling: a plurality of network devices includes coupling a central control point to an RF distribution system, coupling a plurality of receiver devices to the RF distribution system, coupling one or more of the plurality of network devices to each receiver device, configuring a unidirectional signaling path from the central control point through the RF distribution network and the plurality of receivers to each of the plurality of network devices, generating control signals at the central control point, and transmitting the control signals via the unidirectional signaling path to a select one or more of the plurality of network devices. The method further comprises applying control commands corresponding to the control signals to the select one or more of the plurality of network devices. The method further comprises adding a destination address to each control signal to identify the select one or more of the plurality of network devices. Each receiver device includes a receiver device address, and if the select one or more of the plurality of network devices corresponds to a single receiver device, then the destination address comprises a single receiver device address. If the select one or more of the plurality of network devices corresponds to more than one receiver device, then the destination address comprises a group address. Generating control signals comprises inputting control commands to the central control point by a user. Alternatively, generating control signals comprises automatically generating control commands by a scheduling algorithm. Generating control signals further comprises converting the control commands to the control signals according to a control system application.

In yet another aspect, a central control point to centrally control one or more network devices comprises an network interface and a controller coupled to the network interface to provide one-directional signaling through an RF distribution network to one or more network devices, wherein the controller transmits control signals to a select one or more of the one or more network devices. The central control point also includes a master transmitter coupled to the network interface to transmit the control signals to the RF distribution system. The central control point also includes a user interface for inputting control commands by a user, wherein the control commands are converted to the control signals by the controller according to a control system application. The controller includes a scheduling algorithm to automatically generate control commands, wherein the control commands are converted to the control signals by the controller according to a control system application. Each control signal includes one or more device addresses, wherein each device address corresponds to one or more receiver devices, each receiver device coupled to one or more of the one or more network devices.

In still yet another aspect, a receiver device coupled to an RF distribution system and to one or more network devices is configured to provide a one-directional signaling path from the RF distribution system through the receiver device to the one or more network devices, further wherein the receiver device receives-control signals originating from a central control point via the RF distribution system, converts the control signals to control commands, and transmits the control commands to the one or more network devices. The receiver device is identified by a device address, and each control signal includes one or more device addresses that designate the corresponding one or more receiver devices to which the control signal is intended. If the receiver device is identified by the control signal, then the receiver device converts the control signals to control commands and transmits the control commands to the one or more network devices. At least one of the plurality of receiver devices is Sony Infrared Remote Control System (SIRCS) compatible and the one or more network devices coupled to each SIRCS compatible receiver device is a SIRCS compatible network device.

### BRIEF DESCRIPTION OF THE DRAWINGS

FIG. 1 illustrates an exemplary display control system to centrally control a plurality of display devices.

FIG. 2 illustrates an exemplary block diagram of a computing device used as the control device.

FIG. 3 illustrates a screen shot of an exemplary DCS program main menu.

FIG. 4 illustrates a screen shot of an exemplary scheduler box.

FIG. 5 illustrates a screen shot of an exemplary edit dialog box.

FIG. 6 illustrates a screen shot of an exemplary setup menu to edit groups.

Embodiments of the control system are described relative to the several views of the drawings. Where appropriate and only where identical elements are disclosed and shown in more than one drawing, the same reference numeral will be used to represent such identical elements.

### DETAILED DESCRIPTION OF THE EMBODIMENTS

Embodiments of a radio frequency (RF) based control system are directed to a master transmitter and a control device that utilize an RF distribution system, such as a master antenna television (MATV) system, to send remote control commands to remotely connected network devices. Each control command is addressed by group to reach several network devices at the same time. Alternatively, each control command is addressed by individual device to control only a single device. The control system is configured to provide signaling in one direction, from the control device to the network devices. In this uni-directional configuration, status feed back is not provided by a network device to the control device. The unidirectional configuration provides the advantages of eliminating the requirement to make the RF based distribution system bidirectional as well as to reduce overall costs. Additionally, the unidirectional configuration eliminates the requirement that each network device supports status feed back.

Each network device is a display device, such as a television. Alternatively, each network device is any device capable of processing audio and/or video content, such as a VCR, DVD/CD player, or projector. Still alternatively, each network device is any device capable of being controlled be an external means. In one embodiment, each network device is a Sony Infrared Remote Control System (SIRCS) capable device.

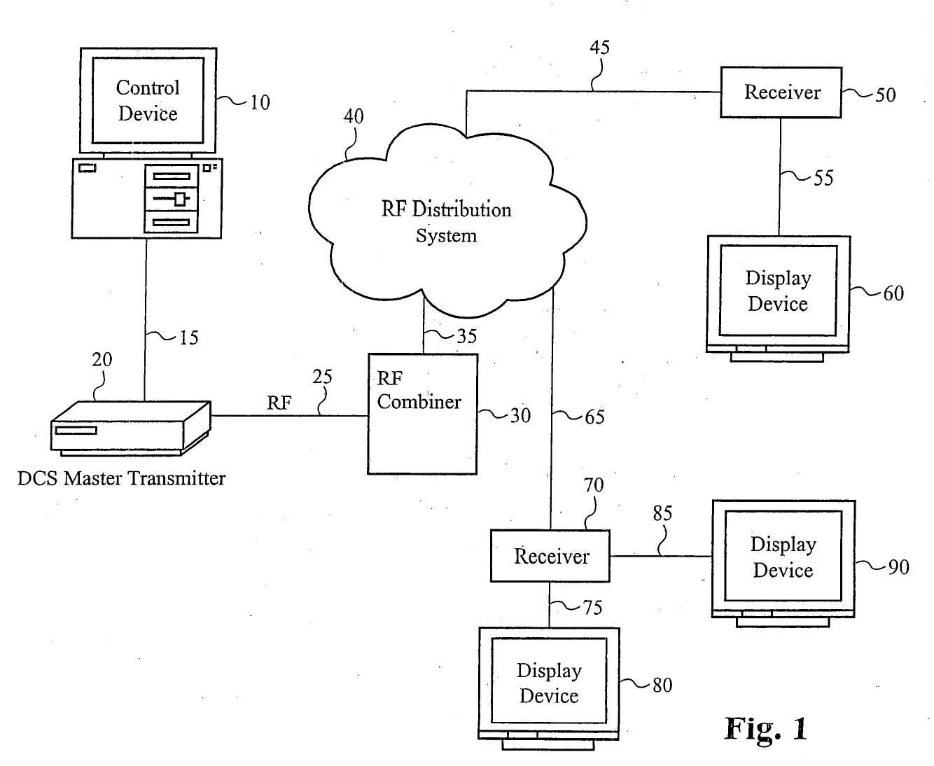

FIG. 1 illustrates an exemplary display control system to centrally control a plurality of display devices. The control system includes a control device 10, a DCS master transmitter 20, an RF combiner 30, an RF distribution system 40, receivers 50 and 70, and display devices 60, 80, and 90. The control device 10 is coupled to the DCS master transmitter 20 via connection 15. Connection 15 is an RS232 network connection. DCS master transmitter 20 is coupled to the RF combiner 30 via connection 25. Connection 25 provides an RF signaling capability. The RF combiner 30 functions as a gateway to the RF distribution system 40 and transmits control signals received from the DCS master transmitter 20 to the RF distribution system 40 via RF connection 35. The RF distribution system 40 transmits control signals to receiver 50 via RF connection 45 and to receiver 70 via RF connection 65. The receiver 50 is coupled to display device 60 via connection 55. The receiver 70 is coupled to display devices 80 and 90 via connections 75 and 85, respectively. A connection between a receiver and a display device, such as connections 55, 75, and 85, is made via a hardwired cable or infrared LED. Each receiver provides control commands to one or more connected display devices, where the control command is broadcast to each display device connected to the receiver. If more than one display device is connected to a receiver, such as the two display devices 80 and 90 connected to receiver 70, then any control command transmitted by the receiver is simultaneously sent to all display devices connected to the receiver. For example, a control command to set the channel to channel 7 is sent by receiver 70 to both display devices 80 and 90.

The RF distribution system 40 broadcasts the control signals to any appropriately configured receiver. To receive an RF transmitted control signal, a receiver must include RF reception capabilities. Each receiver is identified by a receiver address. Each control signal includes a destination addresses which designates the intended receiver(s) for the transmitted control signal. The destination address is either a group address, which designates any receiver associated with a particular group, or the destination address is a single receiver address, which designates a specific receiver. Each receiver connected to the RF distribution system 40 receives the control signal and determines if the destination address included within the received control signal matches its receiver address. If there is a match, then the received control signal is processed by the receiver. In one embodiment, each receiver is a SIRCS capable receiver and the receiver supports all SIRCS capable devices coupled thereto.

The control device 10 is a computing device that includes a display control system (DCS) program algorithm loaded as software. The DCS program uses the computing device's communications port to send a serial control command over connection 15 to the DCS master transmitter 20. The DCS master transmitter 20 broadcasts a corresponding control signal using the RF distribution system 40. In the control system illustrated in FIG. 1, the control device 10 and the DCS master transmitter 20 are separate devices. Alternatively, the DCS master transmitter and the control device are integrated within a single device and the serial control commands are sent from a controller to the DCS master transmitter via an internal bus.

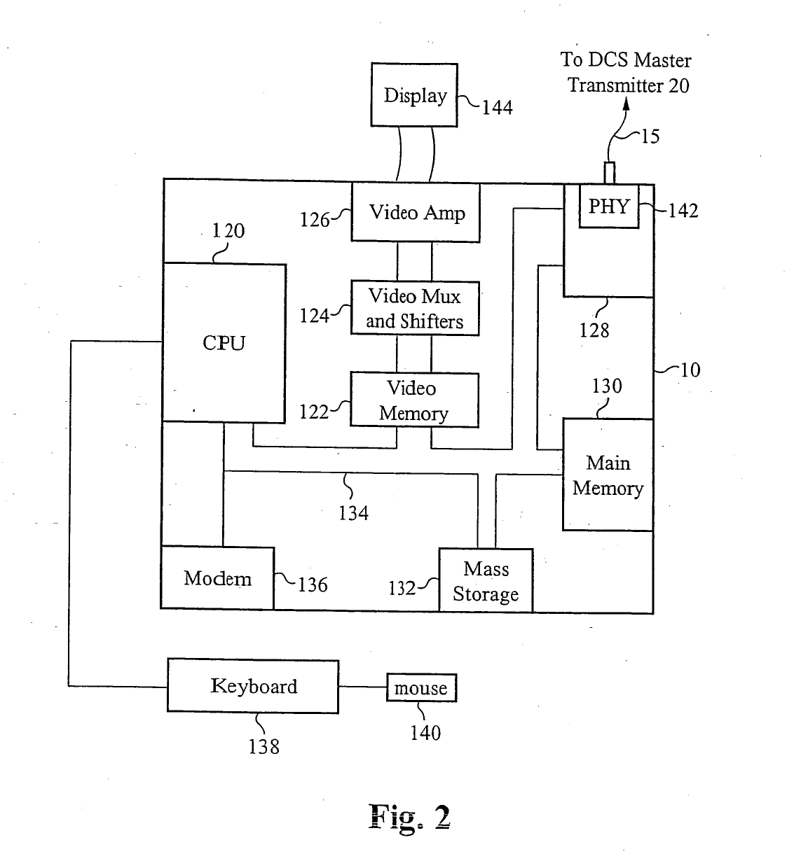

FIG. 2 illustrates an exemplary block diagram of a computing device used as the control device 10. The control device 10 includes a central processor unit (CPU) 120, a main memory 130, a video memory 122, a mass storage device 132, a modem 136, and network interface circuit 128, all coupled together by a conventional bidirectional system bus 134. The modem 136 is preferably coupled to the public switched telephone network (PSTN) for sending and receiving communications. The interface circuit 128 includes the physical interface circuit 142 for sending and receiving communications on the network connection 15 (FIG. 1). The physical interface circuit 142 is coupled to the DCS master transmitter 20 (FIG. 1) over the network connection 15. The interface circuit 128 is implemented on a network interface card within the control device 10. However, it should be apparent to those skilled in the art that the interface circuit 128 can be implemented within the control device 10 in any other appropriate manner, including building the interface circuit onto the motherboard itself. The mass storage device 132 may- include both fixed and removable media-using any one or more of magnetic, optical or magneto-optical storage technology or any other available mass storage technology. The system bus 134 contains an address bus for addressing any portion of the memory 122 and 130. The system bus 134 also includes a data bus for transferring data between and among the CPU 120, the main memory 130, the video memory 122, the mass storage device 132, the modem 136, and the interface circuit 128.

The control device 10 is also coupled to a number of peripheral input and output devices including the keyboard 138, the mouse 140 and the associated display 144. The keyboard 138 is coupled to the CPU 120 for allowing a user to input data and control commands into the control device 10. A conventional mouse 140 is coupled to the keyboard 138 for manipulating graphic images on the display 144 as a cursor control device. As discussed above, a user can utilize the control device 10 to initiate a transaction with a content provider.

A port of the video memory 122 is coupled to a video multiplex and shifter circuit 124, which in turn is coupled to a video amplifier 126. The video amplifier 126 drives the display 144. The video multiplex and shifter circuitry 124 and the video amplifier 126 convert pixel data stored in the video memory 122 to raster signals suitable for use by the display 144.

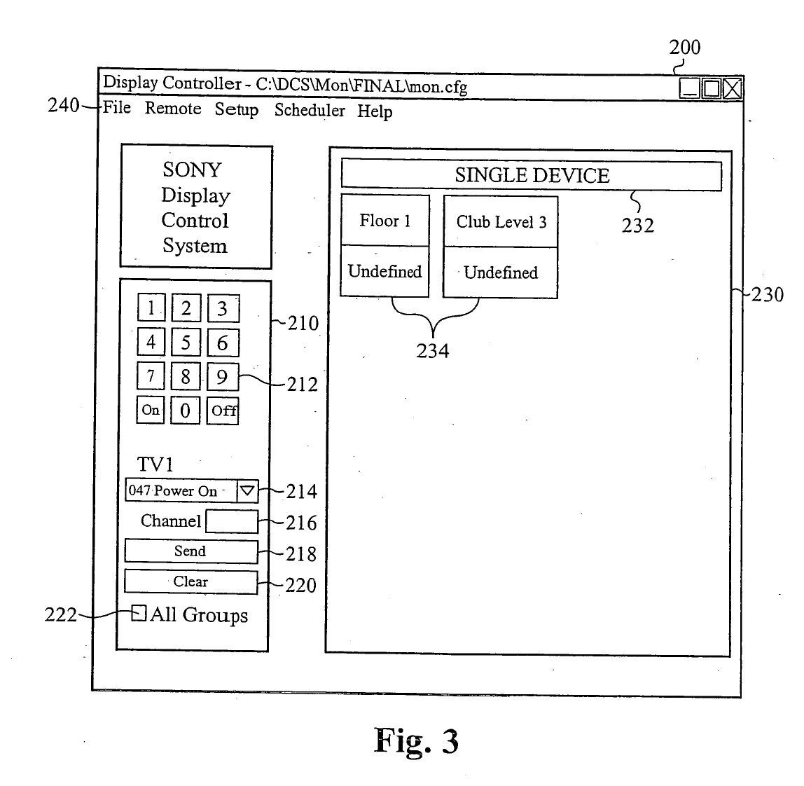

A user accesses the DCS program using a graphical user interface displayed on the display 144. FIG. 3 illustrates a screen shot of an exemplary DCS program main menu 200. The DCS program is the primary user interface for controlling the display devices connected to 30 the control system. The DCS program enables the user to manually send commands, setup a schedule for commands to be sent at specific times, and to change the overall configuration of the control system. The DCS program main menu 200 is divided into two sections, a remote control section 210 and a group display section 230. Before a control command is sent, the user first designates the display device or the group of display devices to which the control command is to be sent. Within the group display section 230, all previously configured groups 234 are displayed, such as those designated “Floor 1” and “Club Level 3” shown in FIG. 3. The group display section 230 also includes a single device box 232. Selecting the single device box 232 opens a list of all individual display devices, allowing the user to select a single display device and to send a control command to the selected display device. To select a specific group of display devices, the user selects one of the groups 234. Upon selecting one of the group boxes 234, the selected group box, such as “Floor 1”, will change color or become highlighted, indicating that a control command can be sent to the selected group.

A control command is selected using the remote control section 210. A drop down list 214 includes a list of available control commands. The list of available control commands is changeable to correspond to a different device type, e.g. a VCR, a DVD/CD player, or a projector. To change the list of control commands within the drop down list 214, the device type is selected from the “Remote” drop down menu in a menu bar 240. Once the device type is selected using the “Remote” drop down menu, a list of control commands corresponding to the selected device type is displayed in the drop down list 214.

A channel box 216 is used to change the channel of the selected display device(s). A send button 218 is used to send the selected control command, as chosen in the drop down menu 214, or the selected channel, as chosen in the channel box 216. The control command is also sent using the “Enter” key on the keyboard 138 (FIG. 2). A numeric keypad 212, or the keyboard 138 (FIG. 2), is used to enter numeric information, such as the channel number, and to turn the selected display device(s) on and off. An “All Groups” radio button 222 is used to disable or enable all groups listed in the group display section 230 at the same time.

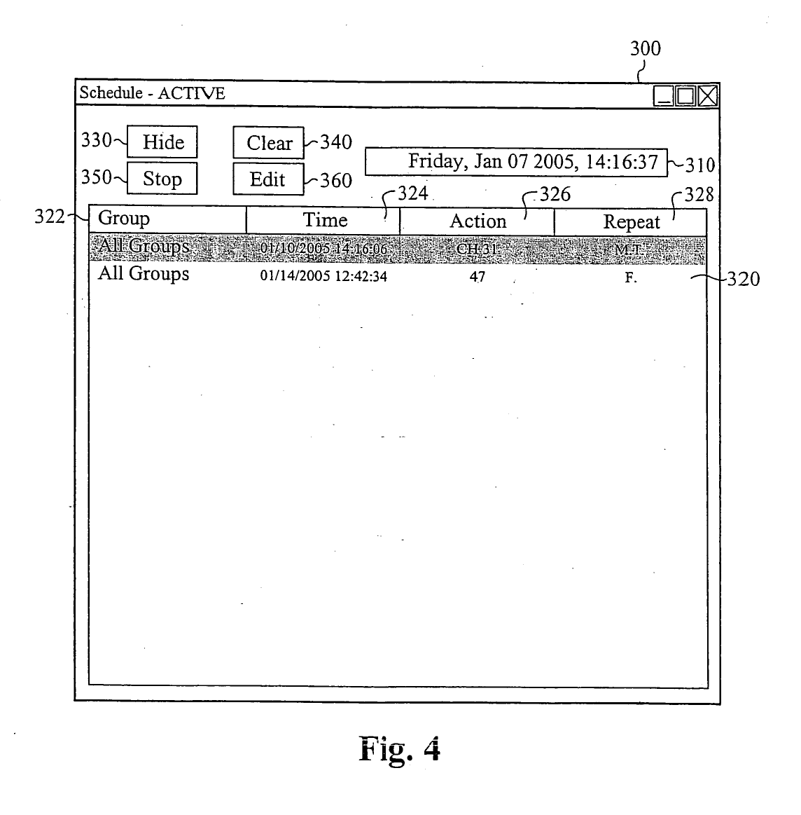

Also included in the menu bar 240 is a “Scheduler” drop down menu. The scheduler allows the user to send commands to groups or to a single device at a predefined time. The scheduled entries are stored in a file “scheduler.dcs” and are accessed using a scheduler box 300, which is illustrated in FIG. 4. Alternatively, the Notepad application is used to access and edit the scheduler.dcs file. The scheduler box 300 includes a current time box 310, a dialog box 320, a hide button 330, a clear button 340, a stop button 350, and an edit button 360. The current time box 310 displays the current time. The dialog box 320 displays a list of scheduled activities, that includes all control commands scheduled to be initiated by the DCS program. Each scheduled activity includes a group parameter, a time parameter, an action parameter, and a repeat parameter, which are displayed within the dialog box under a group header 322, a time header 324, an action header 326, and a repeat header 328, respectively. The group parameter, the time parameter, the action parameter, and the repeat parameter are described in greater detail below.

The hide button 330 hides the dialog box 320 from view. The dialog box 320 is reactivated by again clicking on the hide button 330. The clear button 340 clears all entries in the dialog box 320. The stop button 350 deactivates the scheduler. When the scheduler is deactivated, the stop button 350 changes to “activate” to allow the user to re-enable the scheduler. Use of the stop button 350 enables the user to disable all scheduled control commands without having to clear the scheduled control commands entirely from the scheduler.

The edit button 360 selects any item listed in the dialog box 320 to edit. First, a user selects, typically by highlighting, one of the items listed in the dialog box 320. Once the item is selected, the edit button 360 is clicked. This opens an edit dialog box to allow the user to change the settings of the selected item, which corresponds to a scheduled control command. If no items are listed in the dialog box 320, clicking the edit button 360 opens a default edit dialog box used to create a new scheduled control command.

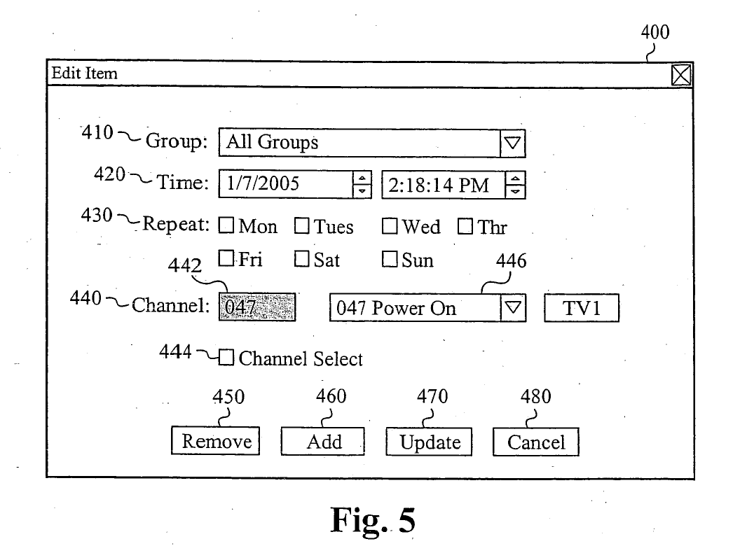

A screen shot of an exemplary edit dialog box 400 is illustrated in FIG. 5. The dialog box 400 includes a group parameter box 410, a time parameter box 420, a repeat parameter box 430, an action parameter box 440, a remove button 450, an add button 460, an update button 470, and a cancel button 480. The group parameter box 410 identifies the group of display devices that is to receive the scheduled control command. The time parameter box 420 identifies the time and the date at which the scheduled control command is to be initiated.

If the same scheduled control command is to be repeatedly initiated according to a known schedule, then the repeat parameter box 430 identifies which days of the week the scheduled control command is to be repeatedly initiated. The action parameter box 440 identifies a control action that is to be performed by the scheduled control command. For example, the action parameter box 440 includes a channel field 442 into which the TV channel for the group of display devices identified by the group parameter box 410 is input. To enable the channel field 442, a channel select field 444 must be selected. Alternatively, the channel select field 444 is not used. The control action to be performed is entered into a control action field 446. Each control action is also identified by a corresponding numeric code. For example, the control action “power on”, as shown in the control action field 446 in FIG. 5, corresponds to the numeric code 047.

Data entered into the group parameter box 410 corresponds to the information displayed under the group header 322 (FIG. 4) within the dialog box 320 (FIG. 4). Data entered into the time parameter box 420 corresponds to the information displayed under the time header 324 (FIG. 4) within the dialog box 320 (FIG. 4). Data entered into the repeat parameter box 430 corresponds to the information displayed under the repeat header 328 (FIG. 4) within the dialog box 320 (FIG. 4). Data entered into the action parameter box 440 corresponds to the information displayed under the action header 326 (FIG. 4) within the dialog box 320 (FIG. 4).

The remove button 450 removes the entry from the system. If the dialog box 400 is accessed to add a new entry, then the add button 460 adds the new entry to the system. The new entry includes the parameters set in the group parameter box 410, the time parameter box 420, the repeat parameter box 430, and the action parameter box 440. If the dialog box 400 is used to edit, or update, an existing entry, then the update button 470 updates the existing entry with the parameters set in the group parameter box 410, the time parameter box 420, the repeat parameter box 430, and the action parameter box 440. The cancel button 480 closed the dialog box 400 without making any changes.

All individual devices and each group are defined by configuration settings. Configuration settings for each device and group are stored in a corresponding configuration file. One of the configuration files is selected to be the default file that loads during the DCS program startup. During runtime, the DCS program, or via a text editor like the Notepad application, enables the user to select and edit different configuration files. To edit the configuration file during runtime of the DCS program, the “Setup” menu is selected from the menu bar 240 (FIG. 3) in the DCS program main menu 200 (FIG. 3), and “edit groups” is selected from the “Setup” menu.

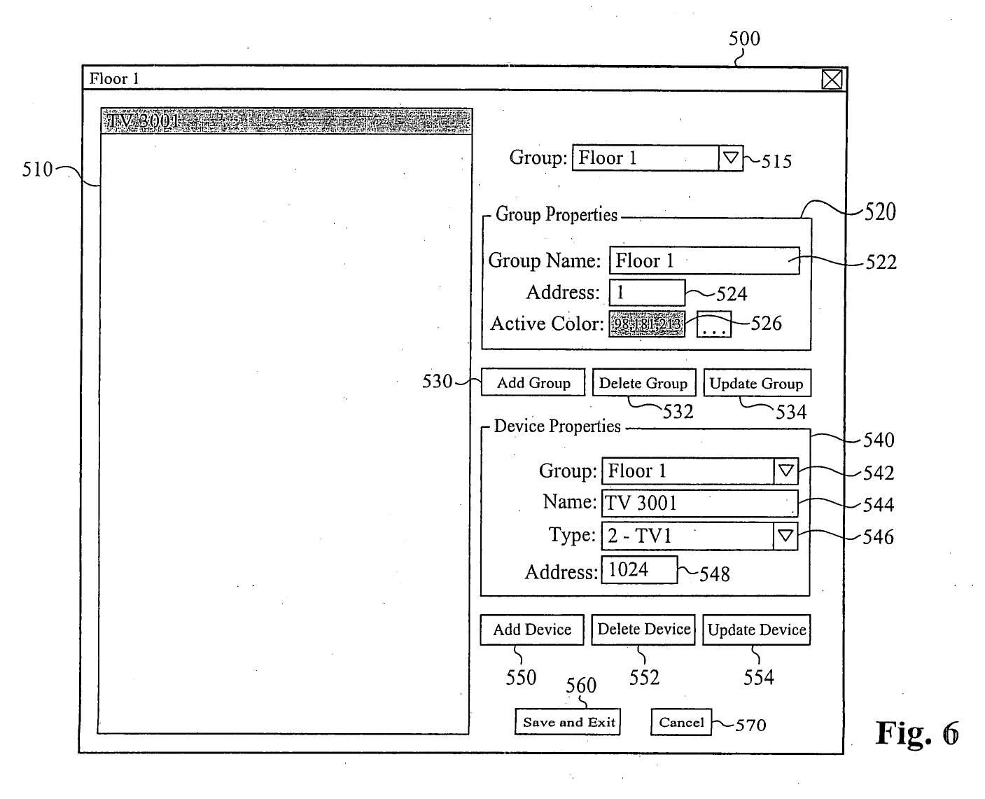

FIG. 6 illustrates a screen shot of an exemplary edit configuration box 500. The edit configuration box 500 is used to edit a configuration file. The edit configuration box 500 includes a group display 510, a group selection box 515, a group properties box 520, an add group button 530, a delete group button 532, an update group button 534, a device properties box 540, an add device button 550, a delete device button 552, an update device button 554, a save and exit button 560, and a cancel button 570.

The group selection box 515 is used to select a specific group. A drop down menu is provided that lists all previously added groups by group name. By selecting a group from the drop down menu, the device names of all individual devices associated with the selected group are displayed in the group display 510. The group properties box 520 defines group configuration settings associated with each group. The group configuration settings include a group name, a group address, and an active color, each of which is selected and displayed in a group name field 522, a group address field 524 and an active color field 526, respectively. Upon selecting a group in the group field 515, the group configuration settings associated with the selected group are populated within the group name field 522, the group address field 524, and the active color field 526. The group name is the name of the group as it appears in the group selection box 515. The address of the group matches a group address of the receiver. The group address is used by convention to describe a list of all individual receiver addresses included within a given group. Alternatively, the group address is an actual address different than the individual receiver addresses, where each individual receiver address included within the group is associated with the group address. The active color is the color of the group button 234 (FIG. 3) when the group is activated.

When a new group is to be added and configured, the add group button 530 is used. Clicking the-add group button 530 enables the group properties box 520 so that the group name, the group address, and the active color parameters can be set. The delete group button 532 deletes the group selected in the group selection box 515. When a group is deleted, the corresponding group button 234 (FIG. 3) on the DCS program main menu 200 (FIG. 3) is removed. Deleting a group does not change or remove any individual device settings. The update group button 534 updates an existing configuration for the group selected in the group selection box 515. When updating the group, the configuration parameter settings specified in the group properties box 520 are used.

The device properties box 540 defines device configuration settings associated with a specific device. The device configuration settings include the group name, a device name, a device type, and a device address, each of which is selected and displayed in an associated group field 542, a device name field 544, a device type field 546, and a device address field 548, respectively. Upon selecting a specific device from the list in the group display 510, the device configuration settings associated with the selected specific device are populated within the associated group name field 542, the device name field 544, the device type field 546, and the device address field 548. Each of the device configuration settings can be edited. The group name specifies the name of the group that the specific device is associated with. The device name is the name of the specific device as it appears throughout the DCS program. The device type specifies the type of device such as a television, DVD/CD player, or VCR. The device address is the address of the specific device.

When a new device is to be added to a group, the add device button 550 is used. Clicking the add device button 550 enables the device properties box 540 so that the group name, the device name, the device type and the device address parameters can be set. The delete device button 552 deletes the device specified in the device properties box 540 from the group designated in the group selection box 515. The update device button 554 updates an existing configuration for the device designated in the device properties box 540. When updating the device, the configuration parameter settings specified in the device properties box 540 are used.

In operation, a control system includes a central control point that provides control commands to a plurality of connected network devices according to a DCS program algorithm. Each of the network devices is coupled to a receiver. Alternatively, each receiver is coupled to more than one network device. The central control point is a computing device coupled to a DCS master transmitter. Control commands sent from the central control point to the DCS master transmitter are broadcast by the DCS master transmitter to the plurality of receivers via an RF distribution system. Each receiver in turn provides a corresponding control signal to each appropriate network device coupled thereto.

The RF distribution system is a MATV system. Alternatively, the RF distribution system is any network that provides RF signals from the DCS master transmitter to the plurality of receivers. The control system is configured to provide a unidirectional signaling path from the central control point to each of the plurality of network devices. In this manner, control signals generated by the central control point are sent to one or more select network devices using the uni-directional signaling path.

The DCS program provides transmission of the serial control command as serial data. The serial data is sent via the master transmitter to each receiver in broadcast mode such that each receiver receives the data at the same time. Embedded in the data is the device or group address that indicates which receiver(s) should process the data. In one embodiment, the serial control command is formatted to include two sections, a command section and a remote control signal section.

The command section includes a start byte, a command group, a device/group address, a command byte, and an end byte. The start byte is one byte long and is designated by Hex 88. The end byte is one byte long and is designated by Hex EE. The start byte and the end byte signal the beginning and end of a given serial command, respectively. The device/group address is 2 bytes long and designates the group or device address to which the control signal is to be sent. The command byte is 2 bytes long and provides data used according to the function designated by the command group. The command group is one byte long and includes one of the codes listed in table 1 below:

TABLE 1

| CODE | FUNCTION |
|---|---|
| Hex 22 | Group Command |
| Hex 33 | Device Command |
| Hex 26 | Group Command with IR |
| Hex 36 | Device Command with IR |
| Hex 44 | Group Write Command |
| Hex 55 | Address Write Command |
| Hex 66 | Group Address Write Command |
| Hex 77 | Group and Device Address Reset |

The Group Command indicates that the command byte is sent to the devices specified in the group address. The Device Command indicates that the command byte is sent to the device specified in the device address. The Group Command with IR indicates that the transmitted infrared signal, with the duration specified in the command byte, is sent to the devices specified in the group address. The Device Command with IR indicates that the transmitted infrared signal, with the duration specified in the command byte, is sent to the device specified in the device address. The Group Write Command indicates that the devices specified in the group address are to change their group address to the value specified in the command byte. The Address Write Command indicates that the device specified in the device address is to change its device address to the value specified in the command byte. The Group Address Write Command indicates that the device specified in the device address is to change its group address to the value specified in the command byte. The Group and Device Address Reset indicates that if the command byte is hex 11, hex 22, then the device and group address is reset to zero. This is done for testing and during the manufacturing process, but not used at an installation.

The specific hexadecimal codes described above are for exemplary purposes only. It is understood that different codes can be used and that additional functions can be defined.

The second section in the serial control command is the remote control signal section that indicates the actual remote control signal that is to be executed by the designated end receiver(s). When the command group code is either the Group Command with IR (hex 26) or Device Command with IR (hex 36), this signals the receiver that the remote control signal included within the serial control command is to be sent directly to the receiver output. This method places the signal generation on the transmitter side and thus simplifies any software updates. The duration of the infrared signal is specified in the two command bytes. The format of the remote control signal depends on the manufacturer of the device that the receiver controls and essentially mimics the signal that the manufacturer's physical remote control would generate to control the device.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention. Specifically, although the control system is described above primarily in context of a display control system, it is understood that the control system is also utilized in control applications other than display.

What is claimed is:

1. A system to centrally control a plurality of network devices, the system comprising:
a. an RF distribution system;
b. a plurality of receiver devices coupled to the RF distribution system;
c. one or more of a plurality of network devices coupled to each receiver device; and
d. a central control point coupled to the RF distribution network to provide one-directional signaling from the central control point through the RF distribution network and the plurality of receivers to the plurality of network devices, wherein the central control point transmits control signals to a select one or more of the plurality of network devices.

2. The system of claim 1 wherein the RF distribution system comprises a master antenna television system.

3. The system of claim 1 wherein at least one of the plurality of network devices comprises an audio/video device.

4. The system of claim 1 wherein the central-control point comprises a control device to generate the control signals and a master transmitter to transmit the control signals to the RF distribution system.

5. The system of claim 4 wherein the master transmitter and the control device comprise an integrated device.

6. The system of claim 4 wherein the master transmitter and the control device are coupled via a serial communication connection to send the control signals from the control device to the master transmitter.

7. The system of claim 4 wherein the control device further comprises a user interface for inputting control commands by a user, wherein the control commands are converted to the control signals by the controller according to a control system application.

8. The system of claim 4 wherein the control device further comprises a scheduling algorithm to automatically generate control commands, wherein the control commands are converted to the control signals by the controller according to a control system application

9. The system of claim 1 wherein each receiver device is identified by a device address, and each control signal includes one or more device addresses that designate the corresponding one or more receiver devices to which the control signal is intended.

10. The system of claim 9 wherein each receiver device identified by the control signal transmits control commands to the one or more network devices coupled to the identified receiver device.

11. The system of claim 1 wherein at least one of the plurality of receiver devices is Sony Infrared Remote Control System (SIRCS) compatible and the one or more network devices coupled to each SIRCS compatible receiver device is a SIRCS compatible network device.

12. The system of claim 1 wherein the system includes one receiver device for each network device.

13. A method of centrally controlling a plurality of network devices, the method comprising:
a. coupling a central control point to an RF distribution system;
b. coupling a plurality of receiver devices to the RF distribution system;
c. coupling one or more of a plurality of network devices to each receiver device;
d. configuring a unidirectional signaling path from the central control point through the RF distribution network and the plurality of receivers to each of the plurality of network devices;
e. generating control signals at the central control point; and
e. transmitting the control signals via the unidirectional signaling path to a select one or more of the plurality of network devices.

14. The method of claim 13 further comprising applying control commands corresponding to the control signals to the select one or more of the plurality of network devices.

15. The method of claim 13 further comprising adding a destination address to each control signal to identify the select one or more of the plurality of network devices.

16. The method of claim 15 wherein each receiver device includes a receiver device address, and further wherein if the select one or more of the plurality of network devices corresponds to a single receiver device, then the destination address comprises a single receiver device address.

17. The method of claim 16 wherein if the select one or more of the plurality of network devices corresponds to more than one receiver device, then the destination address comprises a group address.

18. The method of claim 13 wherein generating control signals comprises inputting control commands to the central control point by a user.

19. The method of claim 18 wherein generating control signals further comprises converting the control commands to the control signals according to a control system application.

20. The method of claim 13 wherein generating control signals comprises automatically generating control commands by a scheduling algorithm.

21. A central control point to control one or more network devices, the central control point comprising:
a. a network interface; and
b. a controller coupled to the network interface to provide one-directional signaling through an RF distribution network to one or more network devices, wherein the controller transmits control signals to a select one or more of the one or more network devices.

22. The central control point of claim 21 further comprising a master transmitter coupled to the network interface to transmit the control signals to the RF distribution system.

23. The central control point of claim 21 further comprising a user interface for inputting control commands by a user, wherein the control commands are converted to the control signals by the controller according to a control system application.

24. The central control point of claim 21 wherein the controller includes a scheduling algorithm to automatically generate control commands, wherein the control commands are converted to the control signals by the controller according to a control system application.

25. The central control point of claim 21 wherein each control signal includes one or more device addresses, wherein each device address corresponds to one or more receiver devices, each receiver device coupled to one or more of the one or more network devices.

26. A receiver device coupled to an RF distribution system and to one or more network devices, wherein the receiver device is configured to provide a one-directional signaling path from the RF distribution system through the receiver device to the one or more network devices, further wherein the receiver device receives control signals originating from a central control point via the RF distribution system, converts the control signals to control commands, and transmits the control commands to the one or more network devices.

27. The receiver device of claim 26 wherein the receiver device is identified by a device address, and each control signal includes one or more device addresses that designate the corresponding one or more receiver devices to which the control signal is intended.

28. The receiver device of claim 27 wherein if the receiver device is identified by the control signal, then the receiver device converts the control signals to control commands and transmits the control commands to the one or more network devices.

29. The receiver device of claim 26 wherein at least one of the plurality of receiver devices is Sony Infrared Remote Control System (SIRCS) compatible and the one or more network devices coupled to each SIRCS compatible receiver device is a SIRCS compatible network device.
